(19) United States
(12) Patent Application Publication
(10) Pub. No.: US 2020/0293965 A1
(43) Pub. Date: Sep. 17, 2020

(54) Enterprise Service Bus

(71) Applicant: Vipin Namboodiri, Bangalore (IN)

(72) Inventor: Vipin Namboodiri, Bangalore (IN)

(73) Assignee: Ricoh Company, Ltd., Tokyo (JP)

(21) Appl. No.: 16/355,238

(22) Filed: Mar. 15, 2019

(51) Int. Cl. G06Q 10/06; G06F 9/448; G06F 9/54; G06F 16/9035

(52) U.S. Cl. CPC G06Q 10/06311; G06F 9/4488; G06F 9/466; G06F 16/9035; G06F 9/542

(57) ABSTRACT

The disclosure includes a system and method for managing statuses of an object associated with an event. A bus controller, in communication with one or more service server, is configured to detect an event associated with a first user; create an object for the event, the object including a first state determined based on a first action of the first user; notify a second user of the event and associated object based on the first state; determine whether a second action of the second user associated with the object has been conducted; and responsive to determining that the second action has been conducted, modify the first state of the object to a second state.

### BACKGROUND

### 1. Field of the Invention

The specification generally relates to maintaining stateful objects in a distributed computing environment. In particular, the specification relates to a system and method for managing statuses of an object associated with an event to streamline an event processing workflow in a distributed environment.

### 2. Description of the Background Art

As technologies grow rapidly, people are facing difficult workflow management problems when dealing with all kinds of services. For example, telemedicine provides healthcare solutions for patients that are geographically separated from care-givers, which requires different participants from different locations to execute part of workflow steps within different disciplines, and thus complicates the workflow execution and management. Also, there is no unified interfaces for interacting with different participants and for handling different types of services. Moreover, existing workflow management architectures are not implemented in real-time.

### SUMMARY

The techniques introduced herein overcome the deficiencies and limitations of the prior art, at least in part, with a system and method for managing statuses of an object associated with an event. The system is configured to detect an event associated with a first user. The system is further configured to create an object for the event, the object including a first state determined based on a first action of the first user. The system is further configured to notify a second user of the event and associated object based on the first state. The system is further configured to determine whether a second action of the second user associated with the object has been conducted. The system is further configured to, responsive to determining that the second action has been conducted, modify the first state of the object to a second state.

Other aspects include corresponding methods, systems, apparatuses, and computer program products for these and other innovative aspects.

The features and advantages described herein are not all-inclusive and many additional features and advantages will be apparent to one of ordinary skill in the art in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 depicts a high-level block diagram illustrating one embodiment of a system for maintaining stateful objects in a distributed computing environment.

FIG. 2 depicts a block diagram illustrating one embodiment of a computing device including a bus controller.

FIG. 3 depicts a flow diagram illustrating one embodiment of a method for identifying an object and associated event information for presenting to a user.

FIG. 4 depicts a flow diagram illustrating one embodiment of a method for managing statuses of an object associated with an event.

FIG. 5 depicts a flow diagram illustrating one embodiment of a method for identifying an object and modifying a status of the object based on user inputs.

### DETAILED DESCRIPTION

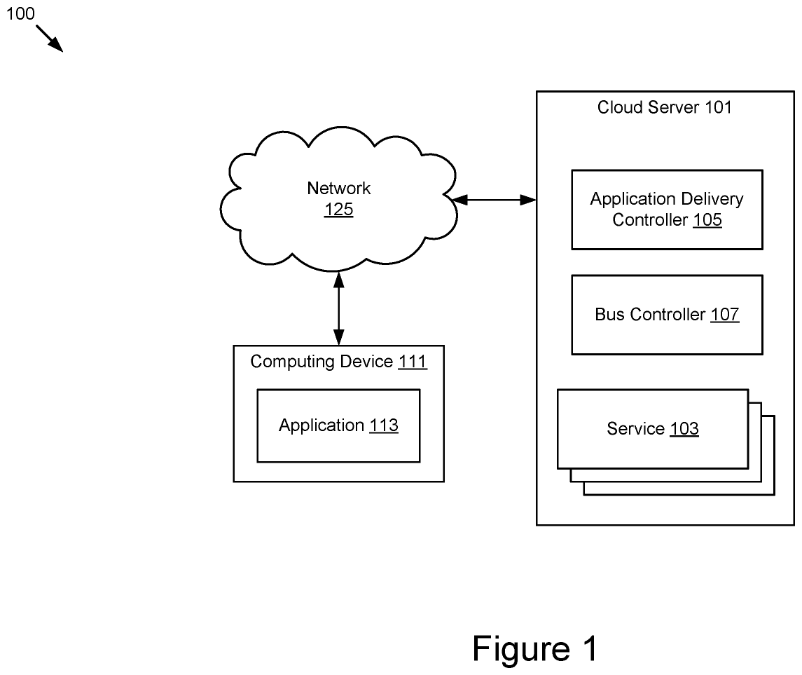

FIG. 1 depicts a high-level block diagram illustrating one embodiment of a system 100 for managing statuses of an object associated with an event. The illustrated system 100 includes a cloud server 101, including an application delivery controller 105, a bus controller 107, and services 103, and a computing device 111. In the illustrated embodiment, the entities of the system 100 are communicatively coupled via a network 125.

Although FIG. 1 and other figures may be described in a specific context, e.g., a cloud-based telemedicine system 100, it is to be understood that the components illustrated and the techniques described herein may also apply to workflow management in other systems and configurations. For example, in different embodiments, a computing device can be accessed by a bank customer, an internet user, a client, etc. Services may include a banking service, online ecommerce service, consultant service, etc. The techniques described herein can be utilized to manage complex and scalable workflows from various service providers for various customers in various formats.

The network 125 can be a conventional type, wired or wireless, and may have numerous different configurations including a star configuration, token ring configuration or other configurations. Furthermore, the network 125 may include a local area network (LAN), a wide area network (WAN) (e.g., the Internet), and/or other interconnected data paths across which multiple devices may communicate. In some embodiments, the network 125 may be a peer-to-peer network. The network 125 may also be coupled to or include portions of a telecommunications network for sending data in a variety of different communication protocols. In some embodiments, the network 125 may include Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 125 coupled to the cloud server 101, the nodes 109, and the hubs 111, in practice one or more networks 125 can be connected to these entities.

The computing device 111 is a computing device including a processor, a memory, applications, a database, and network communication capabilities. For example, the computing device 111 can be a laptop computer, a desktop computer, a tablet computer, a mobile telephone, a personal digital assistant (PDA), a mobile email device, a television with one or more processors embedded therein or coupled thereto or any other electronic device capable of accessing the network 125 and communicating with other entities of the system 100.

The computing device 111 receives and sends data to and from a user accessing the computing device 111. For example, the computing device 111 may receive a request for information about certain event(s) from a user, and communicate with the cloud server 101 to process the request and return the requested information to the user.

A cloud server 101 may be either a hardware server, a software server, or a combination of software and hardware. The cloud server 101 may be, or may be implemented by, a computing device including a processor, a memory, applications, a database, and network communication capabilities.

In some embodiments, the cloud server 101 includes a bus controller 107. The bus controller 107 may include software and/or logic to provide the functionality for managing statuses of an object associated with an event. In some embodiments, the bus controller 107 can be implemented using programmable or specialized hardware. In some embodiments, the bus controller 107 can be implemented using a combination of hardware and software.

The one or more services, collectively referred to hereafter as service 103, includes hardware, software, and/or firmware that allows a service provider to provide service(s), and detects and reports event(s) occurred during the service providing process. For example, a healthcare provider may use the service 103 to search for patients, schedule patients, order prescriptions, make notes, perform video conferencing, generate reports, perform analytics, etc. In another embodiment, service 103 may be a banking service, an e-commerce service for facilitating a transaction with a shopper, a search service for searching and retrieving requested information for an internet user, etc.

In addition to providing services, in some embodiments, the service 103 also detects and reports an event that has occurred during the service providing process. For example, the service 103 may receive an input indicating that a patient has checked in for a telemedicine session and report a check-in event associated with the patient. As described, the event detected by the service 103 may occur during the process of providing a service, but the event itself may not necessarily be related to the service.

In some embodiments, the service 103 reports an event by sending event data associated with the event to other components of the cloud server 101 for further processing. For example, the service 103 may report event attribute(s) associated with the event, such as an event identifier, an event description, a time stamp indicating when the event occurs, a user associated with the event, a source identifier indicating from which device the event is detected and/or reported, etc., and sends the event attributes to the cloud server 101.

The application delivery controller 105 includes hardware, software, and/or firmware that enables the service 103 to interact with other entities of the system 100. In some embodiments, the application delivery controller 105 provides a single interface to communicate the service 103 that provides various types of services to the computing device 111. For example, the application delivery controller 105 may establish a HyperText Transfer Protocol (HTTP) channel to connect the service 103 to an application 113 running on the computing device 111.

The application delivery controller 105 also performs authentication, authorization and/or other access control functionality to serve as a gateway to the services 103. In some embodiments, the application delivery controller 105 may implement authorization at a high-level, e.g., determining whether to authorize a user to access a certain database, to efficiently and effectively gate the services with reduced network resources cost, while leave authorization in a more granular level, e.g., determining whether to authorize a user to access certain data stored on a certain database, to the cloud server 101 as described below.

In some embodiments, there may be different types of services provided by different systems, e.g., different cloud systems other than the cloud system 100. The bus controller 107 connects to these services securely, accepts events related to different types of services, and provides a consistent way to enable complex workflows designed for these services to be implemented.

In some embodiments, the bus controller 107 creates an event object (also referred as “object”) for an event detected by the service 103. The object may include different types of fields depending on different events. A field indicating what has caused an injury and a field indicating an injury level may be included in an object created for a finger-injury incident but not in an object created for a bank transaction. However, in all cases, the bus controller 107 ensures that at least one of the different types of fields indicates a status of the object. This status may correspond to a stage of the event that is being processed, and is updated by the bus controller 107 in real-time.

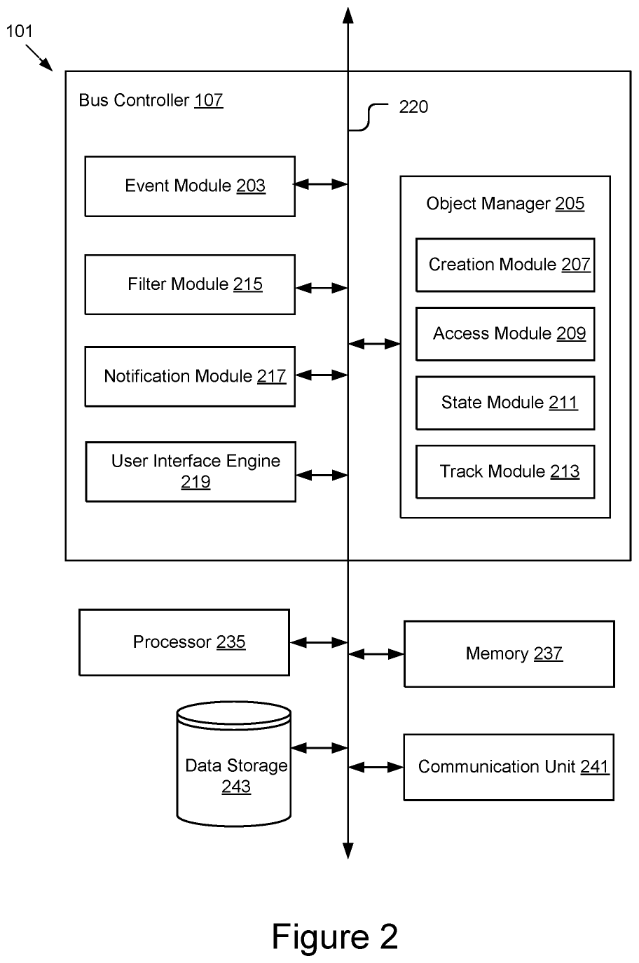

In some embodiments, the bus controller 107 may detect whether a certain action has been done and determine/modify a status of an object based on the detected action. For example, if the event is room renovation, the bus controller 107 may determine statuses to be design consultation, contraction consultation, design completion, permission ready, material ready, contractor ready, renovation start, renovation check, renovation completion depending on the progressing of the renovation. The bus controller 107 not only determines a current status, more importantly, the bus controller 107 identifies and notifies a next user in the workflow of the current state such that a next step in the workflow can be implemented in time with the cooperation of the next user, thereby smoothing and facilitating the processing workflow. The operation of the bus controller 107 and the functions listed above are described below in more detail with reference to FIGS. 2-5.

The techniques described herein are advantageous in various aspects. First, the system described herein supports event-driven real-time service bus, which defines and modifies statuses of an event object in run-time to adapt to the implementation of corresponding workflow steps and any possible changes, and therefore helps realization of a complex and scalable workflow that requires coordination of different people from different departments at different locations. Second, the system described herein provides a consistent view of objects in a distributed system, which helps the system stay focus on streamlining and facilitating the workflow implementation, and is especially useful when the workflow step(s) is/are complicated. Third, the system described herein sends a notification with filtered information of an event to an appropriate user (e.g., a next user in a workflow), which further facilitates the workflow implementation using secure information. This also reduces the network and computer cost that would otherwise be caused by notifying more users with more information.

FIG. 2 depicts a block diagram illustrating one embodiment of a cloud server 101 including a bus controller 107. The cloud server 101 may also include a processor 235, a memory 237, a communication unit 241, and data storage 243 according to some examples. The components of the cloud server 101 are communicatively coupled to a bus or software communication mechanism 220 for communication with each other.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit a plurality of processing units and/or cores. In some implementations, the processor 235 may be capable of generating and providing electronic display signals to a display device, supporting the display of user interfaces used in scheduling a consultation, and performing complex tasks including generating rules, identifying a recommended list of service providers, etc. In some implementations, the processor 235 may be coupled to the memory 237 via the bus 220 to access data and instructions therefrom and store data therein. The bus 220 may couple the processor 235 to the other components of the cloud server 101 including, for example, the memory 237, the communication unit 241, the bus controller 107, and the data storage 243. It will be apparent to one skilled in the art that other processors, operating systems, and physical configurations are possible.

The memory 237 may store and provide access to data for the other components of the cloud server 101. In some implementations, the memory 237 may store instructions and/or data that may be executed by the processor 235. The instructions and/or data may include code for performing the techniques described herein. For example, in one embodiment, the memory 237 may store the bus controller 107. The memory 237 is also capable of storing other instructions and data, including, for example, an operating system, hardware drivers, other software applications, databases, etc. The memory 237 may be coupled to the bus 220 for communication with the processor 235 and the other components of the cloud server 101.

The memory 237 include one or more non-transitory computer-usable (e.g., readable, writeable) device, a dynamic random access memory (DRAM) device, a static random access memory (SRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The communication unit 241 is hardware for receiving and transmitting data by linking the processor 235 to the network 125 and other processing systems. The communication unit 241 receives event data from the service 103, and transmits the event data to the bus controller 107. The communication unit 241 also transmits information to the service 103 or the computing device 111. For example, the communication unit 241 transmits data related to an event to the computing device 111 to notify a user to take an action corresponding to a step of the workflow that is used to process the event. The communication unit 241 is coupled to the bus 220. In one embodiment, the communication unit 241 may include a port for direct physical connection to the network 125. In another embodiment, the communication unit 241 may include a wireless transceiver (not shown) for exchanging data with the computing device 111, the service 103 or any other communication channel using one or more wireless communication methods, such as IEEE 802.11, IEEE 802.16, Bluetooth®, cellular communications, or another suitable wireless communication method.

The data storage 243 is a non-transitory memory that stores data for providing the functionality described herein. In the illustrated embodiment, the data storage 243 is communicatively coupled to the bus 220. The data storage 243 stores information that is used to provide functionality as described herein. For example, the data storage 243 may store event attributes, objects created for events, requests for information of events, filters, notifications of event information, etc. The data stored in the data storage 243 is described below in more detail.

The components of the bus controller 107 may include software and/or logic to provide the functionality they perform. In some embodiments, the components can be implemented using programmable or specialized hardware including a field-programmable gate array (FPGA) or an application-specific integrated circuit (ASIC). In some embodiments, the components can be implemented using a combination of hardware and software executable by processor 235. In some embodiments, the components are instructions executable by the processor 235. In some implementations, the components are stored in the memory 237 and are accessible and executable by the processor 235.

In some embodiments, the bus controller 107 comprises an event module 203, an object manager 205, a filter module 215, a notification module 217 and a user interface engine 219.

The event module 203 may include software and/or logic to provide the functionality for communicating to the service 103 to obtain event data associated with an event on an object (e.g., create, delete, and/or modify) and for handling a request for event information from a user. In some embodiments, the service 103 detects an event, determines one or more attributes associated with the event, and transmits the event attributes to the event module 203. The event may include identification of the object to be acted on and what action should be taken. For example, the event may create a new object, change the state of an existing object, modify attributes of the object, and/or delete the object.

In other embodiments, the event module 203 signals the service 103 to detect a specific event and transmit back the event data associated with the specific event when the specific event happens. The event module 203 may send a signal for a specific event to the service 103 based on a rule determined based on various attributes. For example, the event module 203 may generate a security rule and signal the service 103 to detect and report every movement between 12 am-6 am in an office. The event module 203 may also generate a rule based on a promotion plan and signal the service 103 to detect transaction(s) for a first product in a first week and detect transaction(s) for a second product in a second week. The service 103 transmits the transaction data of the first and/or second product to the event module 203 such that how promotion is related to profit may be analyzed and improved.

In some embodiments, the event module 203 may also receive filter information from the filter module 215 described below and signal the service 103 to detect a specific event based on the filter information. For example, the event module 203 may notify the service 103 to detect online transactions with a transaction amount over $500 based on a filter from the filter module 215.

Responsive to the event being detected by the service 103, the event module 203 receives event attributes associated with the event, for example, an event identifier, an event description, a time stamp indicating when the event occurs, a user associated with the event, a source identifier indicating from which device the event is detected and/or reported, etc., and passes the event attributes to the object manager 205.

The object manager 205 may include software and/or logic to provide the functionality for managing an object based on an event. The management of an object may include, but is not limited to, creating the object, changing a state of the object, signaling the object (e.g., waiting and detecting a specific event that is happening on the object), clearing/deleting the object, etc. In some embodiments, the object manager 205 includes a creation module 207, an access module 209, a state module 211, and a track module 213.

The creation module 207 may create an event object or an object for an event responsive to receiving an event and associated event attributes from the service 103. In some embodiments, the creation module 207 automatically creates an object. In other embodiments, the creation module 207 interacts with a user and instructs the user to create the object (e.g., using a template).

In some embodiments, the object may be in the form of structured JavaScript object notation (JSON), and include a set of fields related to the event such as a type, a name, a state, a sub-state, etc. The object may be dynamic and non-structured in the sense that it is in the JSON format and thus can be of any types and include any types of fields. This is particularly advantageous because the creation of an object would not be restricted by types of events, an amount of content to be included in the object, types of content to be included in the object, etc., and therefore is adapted to uses in different applications that provide different services.

Although the content of an object may be non-structured, the creation module 207 creates an object container that identifies some object attributes for managing objects. For example, the object container may specify the creation time/date of an object, an object identifier (e.g., an object name, identification number, or the like), the object type, etc. Additional object attributes may be stored within the object in object fields. In some embodiments, the creation module 207 may specify in field(s) of an object at what time and by whom the object is created and at what time the object can be deleted. Regarding the deletion, the creation module 207 may further specify the deletion properties such as whether a creator allows the object to be deleted, which user has the right to delete the object, whether the object is automatically deleted or manually deleted by a user, etc. In some embodiments, the object, or portions of the object, may be compressed to save memory and/or reduce transmission overhead.

The creation module 207 may also communicate with the access module 209 to specify the recipient(s) of an object and define the access right to the object for each recipient. A recipient of an object can be an individual user or a group of users. For example, the access module 209 may specify a recipient of an object to be doctor A such that only this particular doctor can access the object. Or the access module 209 may specify the recipient of the object to be a department such that all doctors in that department can access the object. In some embodiment, the access module 209 may further define different access rights for each recipient. For example, if the recipient of an object includes three doctors of a department, the access module 209 may specify that a first doctor can view the object content, the second doctor can view and modify the object, while the third doctor can view, modify, and delete the object.

The state module 211 may assign and/or modify a status of an object. An object may have one or more statuses/states during a lifecycle of the object from being created to being deleted. In some embodiments, the state module 211 may communicate with the creation module 207 and the track module 213 to determine a state of an object and specify/modify the state in at least one status field of the object. In some embodiments, a condition, e.g., whether a specific action has been conducted, is determined and a state of the object is specified/modified when the condition is met. The condition as well as the state of the object determined based on the condition may correspond to a stage of a workflow. A workflow is used to process the event associated with the object, and is usually determined by an application system or the service server. For example, the creation module 207 may create an incident object responsive to detecting an incident that a worker slipped on a wet floor. The state module 211 may then communicate with the creation module 207 and the track module 213 to determine multiple states for the incident object to correspond to different stages of the processing workflow including incident identification, incident logging, initial investigation and diagnosis, treatment or resolution, clearance for work, and report submission.

In some embodiments, a state may include one or more sub-states to indicate a specific step in a stage of the workflow. For example, the state module 211 incorporating with the creation module 207 and the track module 213 may add two sub-state fields, e.g., “notifying manager” and “notifying nurse,” to indicate that the slippery incident has been reported to both a manager and a nurse when the incident is been processed in the stage of “incident logging.”

In some embodiments, the state module 211 in cooperation with the creation module 207 may determine and specify a first state of an object. The state module 211 may also communicate with the track module 213 to modify a state of an object when a condition is met, or further, to delete the object based on deletion properties after a last state has been determined. The state module 211 updates the state of an object in real-time, thereby facilitating the implementation of a complex workflow.

Additionally, the state module 211 residing on the cloud server 101 modifies a status field of the object and updates the state of the object, which supports atomic operations, specifically conditional and state-based atomic updates, and therefore eliminates race conditions in distributed workflows. The race condition is an undesirable situation that occurs in the distributed workflows when two or more operations are required to be performed at the same time but these operations actually can only be done on a proper sequence.

The track module 213 tracks the processing of the event associated with an object and determines a lifecycle for the object, i.e., the object is created for an amount of time and deleted. Usually the detection of an event, which has occurred during a service providing process, causes the creation of an object for the event, therefore the object may live as long as the application/service exists or may last for an amount of time until a certain action is taken. For example, the track module 213 may communicate with the creation module 207 to create an object when a consultation service for a patient starts and delete the object when the consultation ends. In another example, the track module 213 in combination with the creation module 207 may create an object for an incident when the incident is detected, and delete the object after the incident is resolved.

In some embodiments, the track module 213 may monitor an event processing workflow to detect whether an action has been conducted by a user, and notify the state module 211 to update the state of an object associated with the event responsive to the action being detected. This state update is automatic and in real-time, which is particularly advantageous when the event processing workflow is complex, for example, when multiple participants from multiple locations are involved and multiple actions conducted by multiple participants need to be detected for updating states of the object.

In some embodiments, the track module 213 detects whether an action has been conducted based on a user input, and signals the state module 211 to update the state of the object in response to receiving the user input. For example, the state module 211 may update a state of an object associated with a patient upon receiving a message sent by a nurse via the computing device 111 for changing the state.

The filter module 215 may include software and/or logic to provide the functionality for determining a filter and identifying an object and associated data based on the filter for presenting to a user. In some embodiments, the filter module 215 receives an information request from a user and determines a filter based on the request. For example, a first nurse may request information about all check-in patients between 1 pm-5 pm Monday through Thursday, or a second nurse may request information about every patient of doctor A. The filter module 215 generates different filters based on the different requests from the two nurses.

In some embodiments, the filter module 215 may generate a filter using fields included in an object. For example, based on the first nurse requesting information about all check-in patients between 1 pm-5 pm Monday through Thursday, the filter module 215 may generate a filter: status=“check in,” time=“1 pm-5 pm,” date=“Monday-Thursday,” and recipient=“first nurse.” Based on the filter, the filter module 215 identifies an object from a set of objects created by the creation module 203. In some embodiments, the filter module 215 may also extract data from the identified object based on the filter and communicate with the notification module 217 to provide the extracted data to the recipient. For example, the filter module 215 extracts only data related to the “check in” status to the first user without providing additional information used in other stage(s) of the workflow, e.g., providing no previous prescription information that may be used in a diagnosis stage. This not only reduces network traffic but also increases system security.

In some embodiments, the filter module 215 may transmit the filter to the event module 203 so that the event module 203 can signal the service 103 to detect a specific event. For example, responsive to receiving the filters determined for the two nurses as described above, the event module 203 may signal the service 103 to detect whether a patient has checked in between 1 pm-5 pm Monday through Thursday and whether there is a patient coming to visit doctor A. Once one or more such events are detected and a set of objects corresponding to the one or more events are created, the filter module 215 may identify and provide requested information from an object to the requested user.

The notification module 217 may include software and/or logic to provide the functionality for notifying a user of a message or information related to an object. In some embodiments, the notification module 217 cooperates with the filter module 215 to notify a user of the requested information responsive to a request from the user. Therefore if the filter module 215 receives a user request for the information of a specific event on a specific object with a specific type, the notification module 217 can return the requested information back to the user in real time. In other embodiments, the notification module 217 may cooperate with the creation module 207 and/or the state module 211 to identify and notify an appropriate user of specific information extracted from an object based on a state of the object. For example, the notification module 217 may identify that an incident object is in an “incident logging” state and the action to be taken is “notifying user A” from corresponding fields, and notify user A of this incident object. The notification module 217 may even notify a next user in the workflow to perform a next action based on status and other information included in the object.

The user interface engine 219 may include software and/or logic for providing user interfaces to a user. In some embodiments, the user interface engine 219 communicates with the filter module 215 or the track module 213 to generate user interfaces that allow a user to send an information request, or to send a message that an action has been done. In other embodiments, the user interface engine 219 receives instructions from the notification module 217, and sends graphical user interface data to the computing device 111 via the communication unit 241 causing requested information determined from an object to be displayed in a user interface.

The following example of an object representing a patient in a telemedicine session is a use case that illustrates how an object associated with an event is created and used in a workflow process handling the event. When a patient walks into a healthcare clinic or a telemedicine kiosk an application 113 used by a receptionist or nurse to create an encounter. As part of the encounter, services may be requested by the application 113 from the cloud server 101. The creation module 207 creates an encounter object for this encounter based on the received event attributes. The encounter object may be in a JSON format, for example, and therefore the creation module 207 does not need to know information such as what type of object is going to be created and what information will be included in the object prior to creating the object. The creation module 207 may specify that the creator is nurse A, the recipient is doctor B, the type is encounter, the time of creation, and deletion properties in the encounter object. The creation module 207 may also determine a patient identifier of the patient and reason for visit based on a calendar in the check-in application, and include the patient identifier and reason for visit in corresponding fields of the encounter object. The creation module 207 may further add a status showing that a patient has just checked in and list this “check-in” status as a first status of the encounter object. One skilled in the art should recognize other information, e.g., a randomly-generated counter identifier, may also be included in the encounter object.

Once the encounter object relating to a patient checking-in the kiosk is created, the creation module 207 communicates with the notification module 217 to notify the nurse A of this object. The nurse A is notified because the object information indicates she/he is the creator of the object. The nurse A may also be notified if the recipient of the object includes her/him. The nurse A then takes an action following a workflow that is used to process such check-in event, for example, calling the patient in for consultation. Once the doctor B is ready for consulting the patient, the nurse A may send a message. The track module 213 that monitors the workflow process receives the message and signals the state module 211 to modify the state of the encounter object to “ready.” The track module 213 then continues tracking the workflow process to detect whether an action has been done (e.g., whether a physical test of the patient is conducted), notify the state module 211 to modify a state if a specific condition is met, and notify an appropriate user of the state or to take a next-step action (e.g., notify doctor B to prescribe treatment after the physical test is done). The state module 211 modifies the state of the encounter object in run time until the service, e.g., the consultation, is complete, and delete the object based on the deletion properties.

It should be noted that the system defines an object in the JSON format and provides consistent views of interfaces and objects based on the JSON, and thus all the participants of a workflow, no matter the workflow as shown in the above patient consultation example or other workflows in other service examples, face a same interface and interact with the system using the same interface, which greatly enhances the user experience and widens the practical use of the system.

It should also be noted that the system may provide only the filterable events to a recipient, e.g., the nurse A. For example, the nurse A may tell the filter module 215 via the computing device 111 to send all events of all check-in patients. Responsive to this request, the filter module 215 generates a filter (e.g., status=check in, type=encounter) and signals the service 103 to wait and detect check-in patients as shown in the filter. As a result, the service 103 will only detect and forward the event(s) about the check-in patients, and the nurse A will only be notified when such event happens. This notification of filterable event mechanism greatly reduces the network and computing cost and improves network traffic.

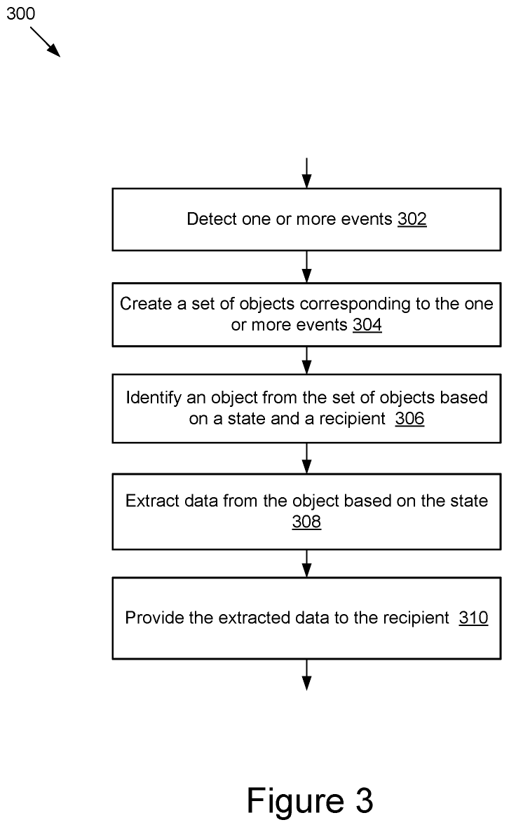

FIG. 3 depicts a flow diagram 300 illustrating one embodiment of a method for identifying an object and associated event information for presenting to a user, which may be implemented by a cloud server 101. The cloud server 101 includes a service 103 and a bus controller 107, which comprises at least an event module 203, an object manager 205, a filter module 215, a notification module 217, and a user interface engine 219. At 302, the service 103 detects one or more events, and transmits event attributes associated with the one or more events to the event module 203. In some embodiments, the event module 203 may receive a filter from the filter module 215 and signal the service 103 to detect only specific event(s). The service 103 determines whether one or more specific events have occurred, and determines and forwards the event attributes associated with an event to the event module 203 when the event actually happens.

At 304, the object manager 205 receives the event attributes associated with the one or more events from the event module 203, and creates a set of objects corresponding to the one or more events. The object may be in the JSON format, and could include any types of content in any types of fields. However, the object manager 205 always includes at least one status field in the object to indicate a current state of the object, which may correspond to a stage of a workflow used to process the event associated with the object.

At 306, the object manager 205 communicates with the filter module 215 to identify an object from the set of objects based on a state and a recipient. For example, if a set of objects are created for all walk-in patients, the object manager 205 may identify from this set an object with status being “check-in” and the recipient being “nurse A” to the nurse A. At 308, the object manager 205 extracts data from the object based on the state, which eliminates the unnecessary information exposure. For example, the information displayed to a specialist is not presented to the nurse A that needs the general information of a “check-in” patient. At 310, the notification module 217 communicates with the user interface engine 219 to provide the extracted data to the recipient.

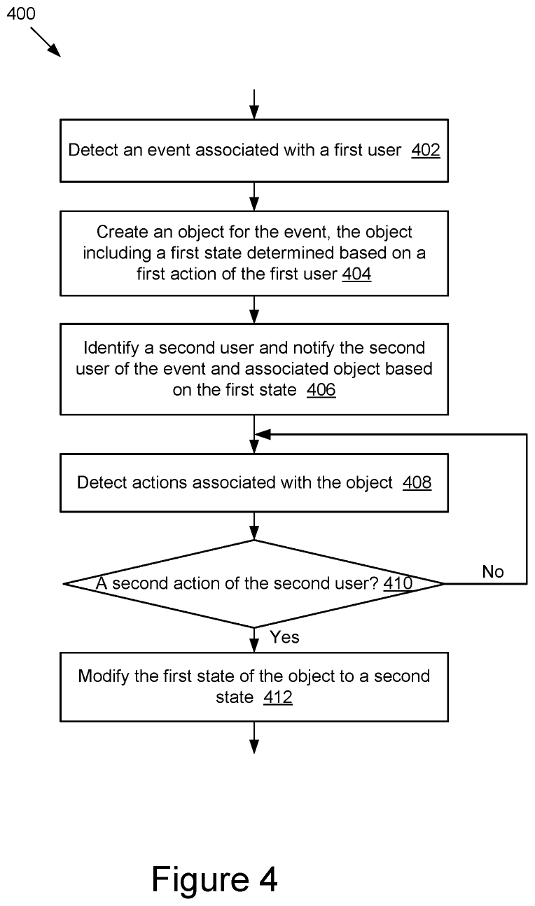

FIG. 4 depicts a flow diagram 400 illustrating one embodiment of a method for managing statuses of an object associated with an event. As described above, the bus controller 107 may include an event module 203, an object manager 205, a filter module 215, a notification module 217, where the object manager 205 includes a creation module 207, a state module 211 and a track module 213. At 402, the event module 203 in communication with the service 103 detects an event associated with a first user, and transmits event attributes associated with the event to the creation module 207. At 404, the creation module 207 creates an object for the event, the object including a first state determined based on a first action of the first user. For example, in response to a patient checking in a counter/a kiosk, the creation module 207 creates an encounter object with a first state of “check-in.” At 406, the state module 211 communicates with the notification module 217 and/or the filter module 215 to identify a second user and notify the second user of the event and associated object based on the first state. Once the encounter object shows the “check-in” state, for example, the state module 211 identifies a nurse (e.g., from the recipient field or the creator field of the object) and the notification module 217 notifies the nurse of the object and/or a second action that the nurse needs to complete. At 408, the track module 213 monitors the workflow used for processing the event and detects actions associated with the object. The track module 213 transmits the detected actions to the state module 211. At 410, the state module 211 determines whether a second action of the second user has been conducted. If the second action has not been conducted, the method 400 moves back to step 408 to continue detecting actions associated with the object. However, if the second action has been done, at 412, the state module 211 modifies the first state of the object to a second state. For example, the state module 211 may change the “check-in” state to a “ready” state once the nurse has called in the patient and sent a message to the system that the patient is ready.

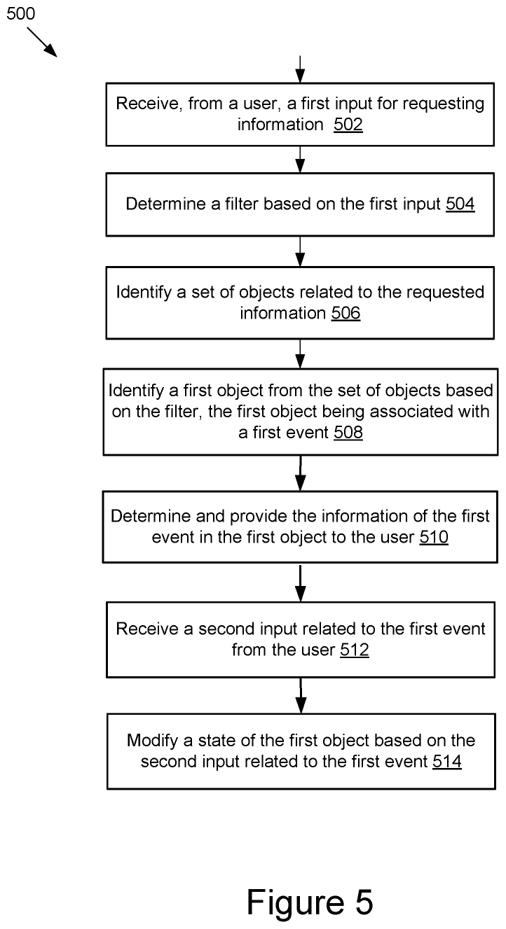

FIG. 5 depicts a flow diagram 500 illustrating one embodiment of a method for identifying an object and modifying a status of the object based on user inputs. As described above, the bus controller 107 may include an object manager 205, a filter module 215, a notification module 217 and a user interface engine 219. At 502, the filter module 215 receives, from a user, a first input for requesting information. At 504, the filter module 215 determines a filter based on the first input. The filter module 215 then communicates with the object manager 205 to identify a set of objects related to the requested information at step 506 and identifies a first object from the set of objects based on the filter at step 508, the first object being associated with a first event. At 510, the filter module 215 also communicates with the notification module 217 and the user interface engine 219 to determine and provide the information of the first event in the first object to the user. For example, a nurse A requests information about all check-in patients via the computing device 111. The filter module 215 receives this request and generates a filter including status=“check-in” and recipient=“nurse A” based on the request. Next the filter module 215 along with the object manager 205 identifies a first object, which shows that patient B just checked in, from a set of objects created for a set of events. As a response to the request, the information about the first object and the associated event is provided to the nurse A in real-time.

At 512, the object manager 205 receives a second input related to the first event from the user. At 514, the object manager 205 modifies a state of the first object based on the second input related to the first event. Once the nurse A gets notified of the first object, the nurse A completes his/her part of workflow step, which causes the state of the first object to be changed to a new state.

A system and method for managing statuses of an object associated with an event has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
detecting an event associated with a first user;
creating, with one or more processors, an object for the event, the object including a first state determined based on a first action of the first user;
notifying a second user of the event and associated object based on the first state;
determining, with the one or more processors, whether a second action of the second user associated with the object has been conducted; and
responsive to determining that the second action has been conducted, modifying, with the one or more processors, the first state of the object to a second state.

2. The method of claim 1, further comprising
identifying and notifying a third user of the event and associated object based on the second state;
determining whether a third action of the third user associated with the object has been conducted; and
responsive to determining that the third action has been conducted, modifying, with the one or more processors, the second state of the object to a third state.

3. The method of claim 1, further comprising:
detecting whether one or more events occur;
responsive to determining that the one or more events occur, creating a set of objects corresponding to the one or more events;
identifying a specific object from the set of objects based on at least one of a specific state and a specific recipient;
extracting data from the specific object based on the specific state; and
providing the extracted data to the specific recipient.

4. The method of claim 1, further comprising:
receiving a data request from the second user;
determining a filter based on the data request; and
wherein notifying the second user of the event and associated object is also based on the filter.

5. The method of claim 1, further comprising:
determining a deletion property associated with the object; and
deleting the object based on the deletion property.

6. The method of claim 1, further comprising modifying the first state of the object to the second state based on a user input.

7. The method of claim 1, wherein the object is in a JavaScript Object Notation (JSON) format, and the method further comprising updating the object in run-time.

8. The method of claim 1, further comprising compressing at least a portion of the object.

9. A system comprising:
one or more processors; and
a memory, the memory storing instructions, which when executed cause the one or more processors to:
detect an event associated with a first user;
create an object for the event, the object including a first state determined based on a first action of the first user;
notify a second user of the event and associated object based on the first state;
determine whether a second action of the second user associated with the object has been conducted; and
responsive to determining that the second action has been conducted, modify the first state of the object to a second state.

10. The system of claim 9, wherein the instructions cause the one or more processors to:
identify and notify a third user of the event and associated object based on the second state;
determine whether a third action of the third user associated with the object has been conducted; and
responsive to determining that the third action has been conducted, modify the second state of the object to a third state.

11. The system of claim 9, wherein the instructions cause the one or more processors to:
detect whether one or more events occur;
responsive to determining that the one or more events occur, create a set of objects corresponding to the one or more events;
identify a specific object from the set of objects based on at least one of a specific state and a specific recipient;
extract data from the specific object based on the specific state; and
provide the extracted data to the specific recipient.

12. The system of claim 9, wherein the instructions cause the one or more processors to:
receive a data request from the second user;
determine a filter based on the data request; and
wherein notifying the second user of the event and associated object is also based on the filter.

13. The system of claim 9, wherein the instructions cause the one or more processors to:
determine a deletion property associated with the object; and
delete the object based on the deletion property.

14. The system of claim 9, wherein the instructions cause the one or more processors to modify the first state of the object to the second state based on a user input.

15. The system of claim 9, wherein the object is in a JavaScript Object Notation (JSON) format, and the instructions further cause the one or more processors to update the object in run-time.

16. The system of claim 9, wherein at least a portion of the object is compressed.

17. A computer program product comprising a non-transitory computer readable medium storing a computer readable program, wherein the computer readable program when executed causes a computer to:
detect an event associated with a first user;
create an object for the event, the object including a first state determined based on a first action of the first user;
notify a second user of the event and associated object based on the first state;
determine whether a second action of the second user associated with the object has been conducted; and
responsive to determining that the second action has been conducted, modify the first state of the object to a second state.

18. The computer program product of claim 17, wherein the computer readable program causes the computer to:
identify and notify a third user of the event and associated object based on the second state;
determine whether a third action of the third user associated with the object has been conducted; and
responsive to determining that the third action has been conducted, modify the second state of the object to a third state.

19. The computer program product of claim 17, wherein the computer readable program causes the computer to:
detect whether one or more events occur;
responsive to determining that the one or more events occur, create a set of objects corresponding to the one or more events;
identify a specific object from the set of objects based on at least one of a specific state and a specific recipient;
extract data from the specific object based on the specific state; and
provide the extracted data to the specific recipient.

20. The computer program product of claim 17, wherein the computer readable program causes the computer to:
receive a data request from the second user;
determine a filter based on the data request; and
wherein notifying the second user of the event and associated object is also based on the filter.
